(19) United States
(12) Patent Application Publication
(10) Pub. No.: US 2018/0142870 A1
(43) Pub. Date: May 24, 2018

(54) PUSH-ON MECHANICAL FASTENER FOR LIGHTING FIXTURE

(71) Applicant: Flex Ltd., Singapore (SG)

(72) Inventor: Jordon Musser, Dallas, TX (US)

(21) Appl. No.: 15/816,460

(22) Filed: Nov. 17, 2017

Related U.S. Application Data
(60) Provisional application No. 62/424,796, filed on Nov. 21, 2016.

(51) Int. Cl. F21V 21/116; F21S 8/06

(52) U.S. Cl. CPC F21V 21/116; F21S 8/063

(57) ABSTRACT

A push-on fastener including a base plate having an opening formed therein for receiving a threaded pipe, at least one pair of tangs formed in the base plate, the tangs formed on opposing sides of the opening, and an internal edge defining a portion of each tang extending into the opening such that the distance between the internal edge of two opposing tangs is less than the diameter of the opening.

### BACKGROUND

### 1. Technical Field

The present disclosure relates to lighting fixtures and, more specifically, to a fastener assembly for securing a lighting fixture in place.

### 2. Discussion of Related Art

Lighting fixtures for high bay facilities are designed for use in buildings with high ceilings or “high bays” such as warehouses, manufacturing facilities, retail stores, or the like. High bay facility ceilings can be between 20 and 60 feet high. Even in buildings of a less industrial application, lighting fixtures are typically 8-10 feet above the floor such that installation requires the use of a ladder.

FIG. 1 depicts a common type of fixture 10 used in many applications. The fixture 10 includes a troffer 12 having a hole 14 formed therein. The hole 14 is sized to receive a pipe 16, typically a ¾ inch pipe with threads 18 formed thereon. The pipe 16 has electrical wires (not shown) extending there through and to a source of electrical energy for powering the fixture 10. The fixture 10 is secured to the pipe 16 with a nut 20, which threads to the threads 18 of the pipe 16, after the pipe 16 is inserted into the hole 14.

A typical troffer 12 can have dimensions from about 24 to about 48 inches in length (or longer) and a width from about 10 to about 20 inches, though other dimensions are possible. In many settings, following insertion of the pipe 16 through the hole 14, an installer may be at the top of a ladder using one hand to hold the fixture 10 in place while attempting to thread the nut 20 on the threads with the other hand. This can create a dangerous situation for the installer, or require the use of a second person in order to limit the risk. Both the possibility of falling and the use of two people can slow the installation process and increase costs for the installer and ultimately the purchaser of the fixture. While the cost and time of installing a single fixture might be insignificant, in a typical new construction or significant retro-fit scenario an installer might be tasked with installing several thousand such fixtures in even a moderately sized building. Accordingly, there is a need to address both the safety and increased manpower concerns related to installation of current lighting fixtures.

### BRIEF DESCRIPTION OF THE DRAWINGS

Various aspects of the present disclosure are described herein below with reference to the drawings, which are incorporated in and constitute a part of this specification, wherein:

FIG. 1 is a known example of a system for securing a lighting fixture;

FIG. 2 is a top plan view of a push-on fastener, in accordance with the present disclosure;

FIG. 3 is a perspective view of push-on fastener, in accordance with another embodiment of the present disclosure;

FIG. 4 is a plan view of the push-on fastener of FIG. 2 secured to a troffer;

FIG. 5 is side view of an installation site to which the troffer and push-on fastener of FIG. 4 may be secured; and

FIG. 6 is the installation site of FIG. 5 with a troffer of FIG. 4 secured thereto using the push-on fastener.

### DETAILED DESCRIPTION

The present disclosure relates generally to lighting fixtures employing a push-on fastener, which enables the initial securing of the lighting fixture to a pipe through which electrical wires and the like for powering the lighting fixture are run. The push-on fastener allows for the lighting fixture to be secured to the pipe without requiring separate hands to hold the lighting fixture and thread a nut onto the threads of the pipe.

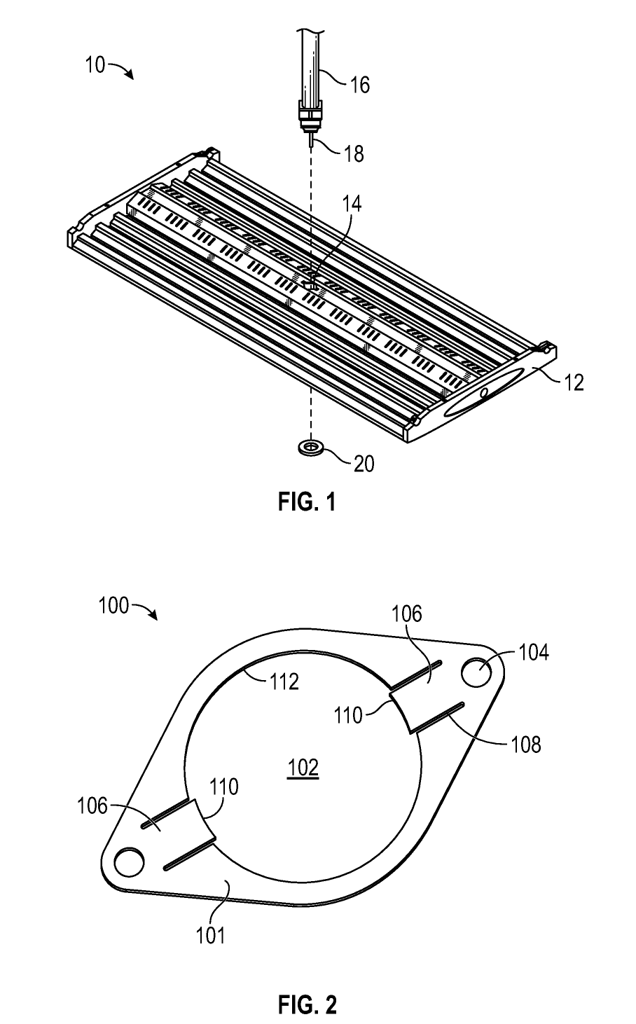

FIG. 2 is a push-on fastener 100 in accordance with the present disclosure. The push-on fastener 100 is formed of a base plate 101 having an opening 102 for receiving a pipe, such as pipe 16 in FIG. 1. The push-on fastener 100 may include one or more attachment holes 104 enabling the push-on fastener 100 to be secured to a troffer 12. In particular, the holes 104 allow the push-on fastener 100 to be secured to either an internal surface or an external surface of the troffer 12 and aligned with the hole 14 formed therein. In another embodiment, rather than employing holes 104, the push-on fastener 100 may be secured to the troffer 12 with an adhesive such as epoxy, or may be welded or brazed to the troffer 12.

The push-on fastener 100 further includes one or more flexible tangs 106 formed by cutting two or more slots 108 in the base plate of the push-on fastener 100. The flexible tangs 106 extend into the opening 102 of the push-on fastener 100 through which the pipe 16 is to pass in the pass. The diameter of the pipe 16 is somewhat larger than the distance between an internal edge 110 of the tang 106 and a surface of the push-on fastener 100 opposite the tang 106. As shown in FIG. 2, the surface opposite the tang 106 is a second tang 106 having a second internal edge 110. However, the surface opposite could also be the edge 112 of opening 102.

The internal edges 110 of the tangs 106 each may have an arcuate shape suitable for engaging the threads 18 of pipe 16. Inclusion of the slots 108 allow the tangs 106 to flex opposite the direction of force applied to the troffer 12, when the threaded pipe 16 is inserted into hole 14 of the troffer 12 and the co-aligned opening 102 of the push-on fastener 100. This flexure creates an effective increased distance between the internal edges 110, as shown in FIG. 2, and allows for the tangs 106 to slide over the threads 18. Upon relaxation of the force applied to the troffer 12, the spring force on the tangs 106 and any memory of the material from which the push-on fastener 100 is formed returns the tangs 106 to their original position, and secures the push-on fastener 100, and the troffer 12 to which it is secured, to the pipe 16. Alternatively or additionally, the internal edge 110 may be sharpened or formed with a burr or hook to further secure the push-on fastener 100 to the threads 18 of the pipe 16.

Once secured to the pipe 16, the installer can release the troffer 12 knowing that it is secured to the pipe 16 and will not fall. This enables the installer to then have both hands available for threading a nut 20 onto the pipe 16 and permanently secure the fixture 10 to the pipe 16.

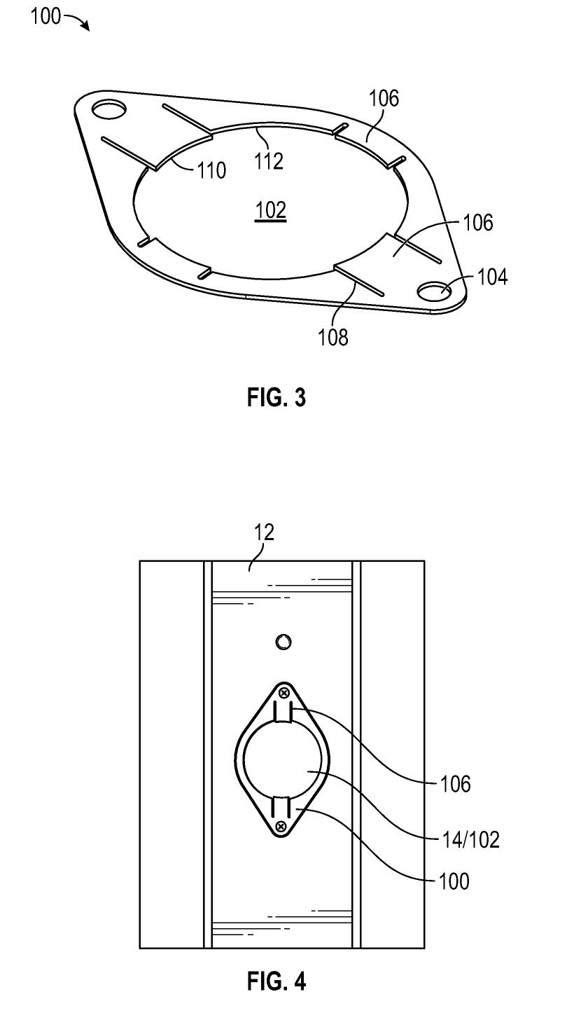

FIG. 3 depicts another embodiment of the present disclosure where instead of two tangs 106a, 106b, four tangs 106a, 106b, 106c, 106d are employed. As shown, two of the tangs 106c, 106d have a shorter length than tangs 106a, 106b. As can be appreciated, these shorter dimension tangs 106 will have greater rigidity than the longer dimension tangs. In this manner, push-on fasteners can be employed based on the weight that they will be required to support. It is contemplated that the push-on fastener 100 of FIG. 3 will require greater force to be placed over the threads 18 of pipe 16, but would also be able to support a greater weight. Further, by providing more than a single pair of tangs 106, the amount of force necessary for installation of a given troffer 12 can be selected by the installer. The installer may determine that for a given fixture 12, not all of the tangs 106 are required. In such an instance, the installer may use pliers or another implement to either bend away or fatigue to the breaking point tangs 106 which are deemed unnecessary for a given application.

The push-on fasteners of FIGS. 2 and 3 are formed in a dual-tear drop shape. This shape has been found to minimize the amount of material required for manufacturing the push-on fastener and eliminate unnecessary waste in the manufacturing process. While this shape has advantages, the present disclosure is not so limited and the push-on fastener may be formed in other shapes including square, rectangular, round, oblong and the like without departing from the scope of the present disclosure.

FIG. 4 depicts the push-on fastener 100 installed on a troffer 12. As shown, the hole 14 in the troffer 12 is aligned with the opening 102 in the push-on fastener 100 such that they are capable of slidingly receiving the pipe 16 and threads 18 as described above. In FIG. 4, the holes 104 provide attachment points for the insertion of rivets, bolts, machine screws, self-tapping screws and the like to secure the push-on fastener 100 to the troffer 12.

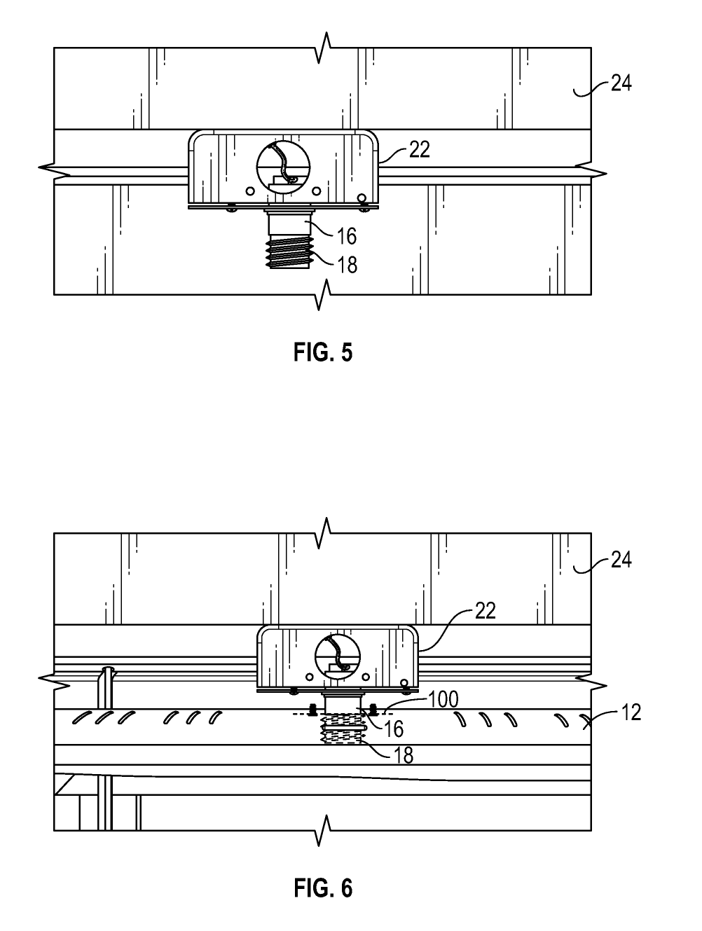

FIG. 5 depicts a typical installation site prior to receiving a troffer 12 having the push-on fastener 100 (e.g., as shown in FIG. 4) of the present disclosure. The installation site includes a junction box 22 mounted to a ceiling 24 and received within it cables and wires for powering a fixture 10. Commonly, the wires would be arranged to descend the pipe 16 and be available for passing through hole 14 of the troffer 12 and opening 102 of the push-on fastener 100.

FIG. 6 depicts the installation site now including the troffer 12 installed on the pipe 16 and ready for the installer to simply thread a nut 20 onto the threads to permanently secure the troffer 12 to the pipe 16. In this configuration, the weight of the troffer 12 is supported by the interaction of the tangs 106 of the push-on fastener 100 with the threads 18 of the pipe 16. The push-on fastener 100 and attached troffer 12 have been slid over the threads 18 on the pipe 16 as described above. This action allows the installer greater flexibility in using their hands for things other than trying to hold the troffer 12 on the pipe 16 while threading the nut 20. As a result, the installation of an individual fixture 10 requires less time and can be performed by a single individual with greater safety.

In some instances, it may be desirable to re-use fixtures 10 that have been previously installed. In such instances an installer may seek to retrofit existing troffers with the push-on fastener 100. In accordance with this need, the push-on fasteners may be offered as a kit having a push-on fastener 100 and one or more fasteners such as self-tapping screws as described above. Alternatively, the push-on fastener 100 may be included in the manufacture of the troffer 12, and come from the factory pre-installed.

In yet a further embodiment, rather than being formed as a separate component, the push-on fastener 100 may be integrally formed as part of the troffer 12. In such instances, the slots 108 are cut into the material of the troffer 12 revealing tangs 106 which provide for the functionality as described herein above.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

1. A push-on fastener comprising:
a base plate having an opening formed therein for receiving a threaded pipe;
at least one pair of tangs formed in the base plate, the tangs formed on opposing sides of the opening; and
an internal edge defining a portion of each tang extending into the opening such that the distance between the internal edge of two opposing tangs is less than the diameter of the opening.

2. The push-on fastener of claim 1, further comprising a plurality of slots forming the boundaries of each tang.

3. The push-on fastener of claim 1, wherein the base plate forms a portion of a troffer.

4. The push-on fastener of claim 1, further comprising one or more holes for attaching the base plate to a troffer.

5. The push-on fastener of claim 1, further comprising multiple pairs of tangs.

6. The push-on fastener of claim 1, wherein the base plate has a dual-tear drop shape.

7. The push-on fastener of claim 1, wherein upon insertion of a threaded pipe through the hole the internal edges of each tang engage the threaded pipe causing the tangs deflect along the threaded pipe permitting the tangs to pass over threaded pipe and upon cessation of a force required for insertion the tangs spring back to their un-deflected position and secure the base material to the threaded pipe.

8. A lighting fixture comprising:
a troffer having a hole formed therein for receiving a threaded pipe; and
a push-on fastener having an opening and at least one pair of tangs, the opening sized to receive a threaded pipe, the at least one pair of tangs formed on opposing sides of the opening, and each tang of the at least one pair of tangs defined by an internal edge extending into the opening such that the distance between the internal edges is less than the diameter of the opening.
